(19) United States
(12) Patent Application Publication
(10) Pub. No.: US 2008/0260196 A1
(43) Pub. Date: Oct. 23, 2008

(54) Earphone receiving structure

(76) Inventor: Tse-Ming Tsai, Sindian City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/785,775

(22) Filed: Apr. 20, 2007

(51) Int. Cl. H04R 11/00

(52) U.S. Cl. 381/380

(57) ABSTRACT

An earphone receiving structure includes a housing and an earphone. The housing has an opening slot. The opening slot is formed by an indent formed inwards from one end of the housing. There is a pair of pivoting holes in the opening slot, and a plurality of concave portions on the inner surface of the pair of the pivoting holes. The earphone has a pair of pivoting shafts. The pair of pivoting shafts is pivoted in the pivoting holes. There is at least one convex portion on the outer surface of the pair of pivoting shafts. The convex portion fits in the concave portions. The earphone is received in the opening slot and can be rotated to the outside of the opening slot. Thereby, the earphone can be received in the housing to prevent the connection point of the earphone from being broken due to external forces.

### BACKGROUND OF THE INVENTION

1. Field of the Invention

The present invention relates to an earphone receiving structure. In particular, this invention relates to an earphone receiving structure that receives the earphone in the housing to prevent the earphone from being broken due to an improper external force. It also provides an angle-adjusting function for the user so that the user feels comfortable when the user is using the device while communicating over the device.

2. Description of the Related Art

Portable electronic communication devices that do not need to be held (such as a wireless earphone) usually include an earphone and a microphone for receiving and transmitting voice data. In order to satisfy the requirements of users, allowing communication at anytime and anywhere as well as providing excellent communication, the earphone is usually plugged into the external auditory meatus of the user.

Because the portable characteristics of wireless earphones are their key selling point, the structure of a wireless earphone is usually light and thin, and the strength is disregarded. Of course, the wireless earphone has to satisfy the characteristics of being handy and durable. Therefore, when a user is not using the wireless earphone, the wireless earphone can be placed into a pocket, a handbag, or a drawer etc, and bears a degree of external force caused by its users or its environment so that its structure is still intact.

FIG. 1 shows a wireless earphone of the prior art. The wireless earphone includes a housing 1a, an earphone 2a, and a microphone 3a.

The housing 1a is rectangular and arced. At one end of the earphone 2a, there is an amplifier 21a. The earphone 2a protrudes from one side of the housing 1a. The amplifier 21a of the earphone 2a is placed into the external auditory meatus of the user to receive the voice data clearly. In the housing 1a, there is a Bluetooth wireless receiving and sending device (not shown in the figure). Therefore, voice signals of the portable electronic device (such as a cell phone) can be transmitted. The microphone 3a is located at an end of the housing 1a that is far away from the earphone 2a that is a sending port for receiving the voice from the user.

However, the wireless earphone of the prior art has a problem in that the earphone 2a can be easily broken. Because the earphone 2a protrudes from one side of the housing 1a, the connection point of the earphone 2a and the housing 1a (the torque is maximum) will be broken when an external force is exerted upon it. Therefore, the user cannot place the wireless earphone arbitrarily. It is inconvenient for the user.

The portable wireless earphone has to overcome challenges from its users and its environment. However, the wireless earphone of the prior art cannot overcome these problems.

Moreover, because the face and the ear for each user are different, the earphone 2a is fastened onto the housing 1a. The angle of the earphone 2a cannot be adjusted to fit its user's face. The quality of communication therefore suffers.

### SUMMARY OF THE INVENTION

One particular aspect of the present invention is to provide an earphone receiving structure. The earphone receiving structure can be placed anywhere arbitrarily, and the problem of the connection point of the earphone being broken due to an external force is avoided.

Another particular aspect of the present invention is to provide an earphone receiving structure. The angle between the housing and the earphone can be adjusted to make the housing attach well to the user's head.

The earphone receiving structure includes a housing and an earphone. The housing has an opening slot. The opening slot is formed by indenting inwards from one end of the housing. There is a pair of pivoting holes in the opening slot, and a plurality of concave portions on the inner surface of the pair of the pivoting holes. The earphone has a pair of pivoting shafts. The pair of pivoting shafts is pivoted in the pair of pivoting holes. There is at least one convex portion on the outer surface of the pair of pivoting shafts. The convex portion of the pair of pivoting shafts fits in the concave portions of the pair of pivoting holes. The earphone is received in the opening slot and can be rotated outside of the opening slot.

The earphone can be received in the housing to prevent the connection point of the earphone from being broken due to an external force. The earphone receiving structure can be placed arbitrarily when the user is not using the earphone receiving structure.

Furthermore, by rotating and positioning the pivoting shaft to adjust the angle between the housing and the earphone, the housing attaches well onto the user's face. It is comfortable for the user, and offers better communication qualities.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is a perspective view of an earphone located on the housing of the prior art;

FIG. 2 is an exploded perspective view of the earphone receiving structure of the present invention;

FIG. 3 is a schematic diagram of the earphone received in the housing of the present invention;

FIG. 4 is a schematic diagram of the earphone protruding outside of the housing of the present invention;

FIG. 5 is a schematic diagram of the operation of the earphone receiving structure of the present invention;

FIG. 6 is another schematic diagram of the operation of the earphone receiving structure of the present invention;

FIG. 7 is a further schematic diagram of the operation of the earphone receiving structure of the present invention;

FIG. 8 is a fourth schematic diagram of the operation of the earphone receiving structure of the present invention; and

FIG. 9 is an assembly perspective view of the housing added with an ear hook of the present invention.

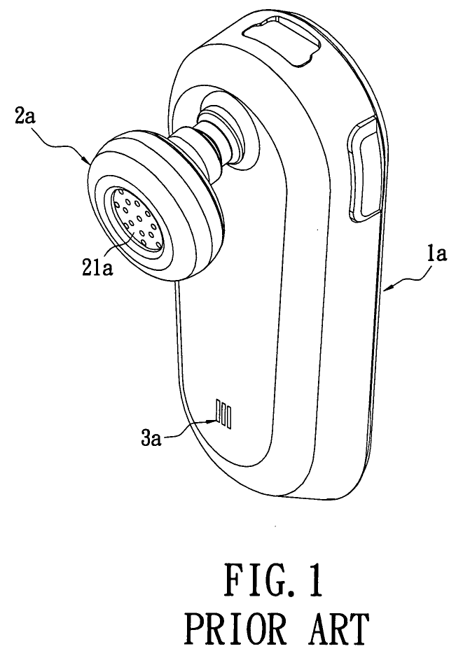

### DETAILED DESCRIPTION OF THE PREFERRED EMBODIMENTS

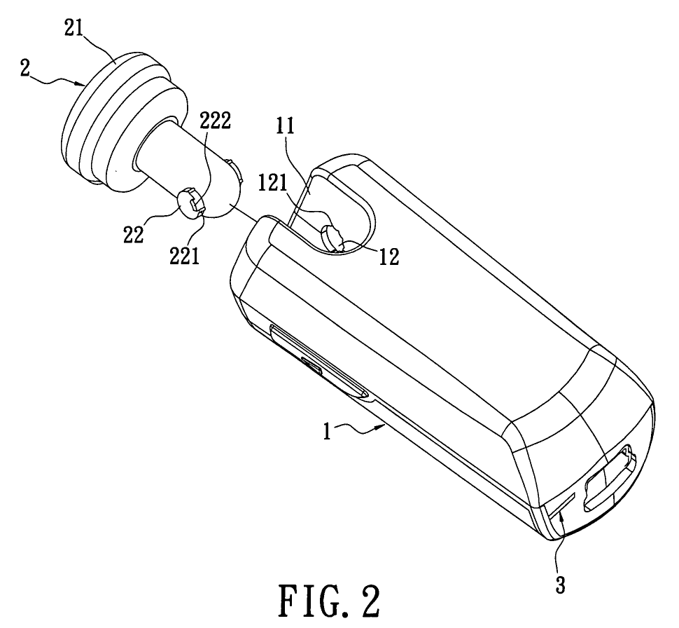

Reference is made to FIGS. 2, 3, and 4. The earphone receiving structure includes a housing 1, an earphone 2, and a microphone 3.

The housing 1 is rectangular and arced. One end of the housing 1 has an opening slot 11. An inner indent from one end of the housing 1 forms the opening slot 11 with a rectangular opening space. The dimensions of the opening slot 11 are enough to receive the earphone 2. There is a pair of circular pivoting holes 12 on the two sides of the opening slot 11 that is adjacent to the bottom of the opening slot 11. There are a plurality of concave portions 121 and a blocking portion 122 on the pair of pivoting holes 12. The concave portion 121 is an arced slot that indents the inner surface of the pivoting hole 12. The blocking portion 122 is a rectangular cubic body that extends from a side wall of the pivoting hole 12. There is a microphone 3 in the housing 1. The microphone 3a is located at another end of the housing 1a that is far away from the opening slot 11 and acts as a sending port. The microphone 3 is located at one location that is close to the user's mouth for receiving the user's voice. There is a Bluetooth wireless receiving and sending device (not shown in the figure) in the housing 1 that is electrically connected with the earphone 2 and the microphone 3 for transmitting a voice signal via a portable wireless communication device, such as a cell phone.

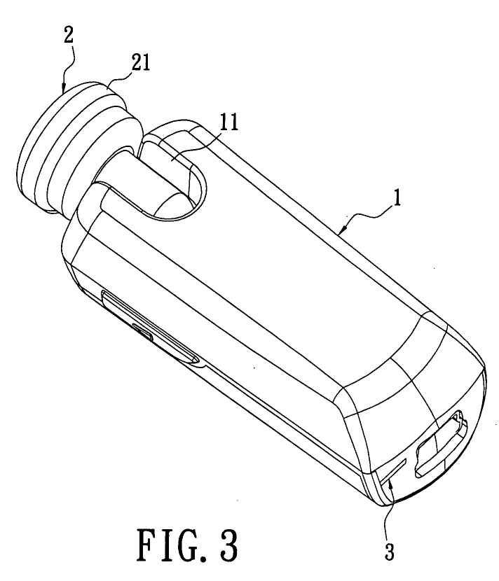

Reference is made to FIGS. 3˜8. The earphone 2 is located in the opening slot 11. One end of the earphone 2 has an amplifier 21 that can extend to the user's external auditory meatus when being used. At an other end of the earphone that is far away from the amplifier 23 there is a pair of pivoting shafts 22. The pair of pivoting shafts 22 extends from the surfaces of the earphone 2 that are opposite to each other. The pair of pivoting shafts 22 are circular columns that correspond to the pivoting holes 12 of the opening slot 11. There are two convex portions 221 on the outer surface of the pair of pivoting shafts 22. The convex portions 221 are semi-spheres that correspond to the concave portions 121. The two convex portions 221 are located on the peripheral surfaces of the pivoting shafts 22 that are vertical to each other. The pair of pivoting shafts 22 of the earphone 2 pivot into the pair of pivoting holes 12 located on both sides of the opening slot 11. Thereby, the earphone is received in the opening slot 11 and can be rotated to an outside of the opening slot 11. The convex portions 221 fit in the concave portions 121 so that the pivoting shafts 22 can be rotated and positioned in the pivoting holes 12 with multiple steps.

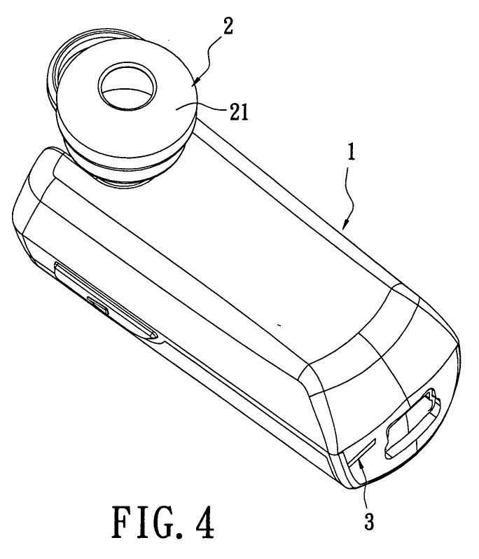

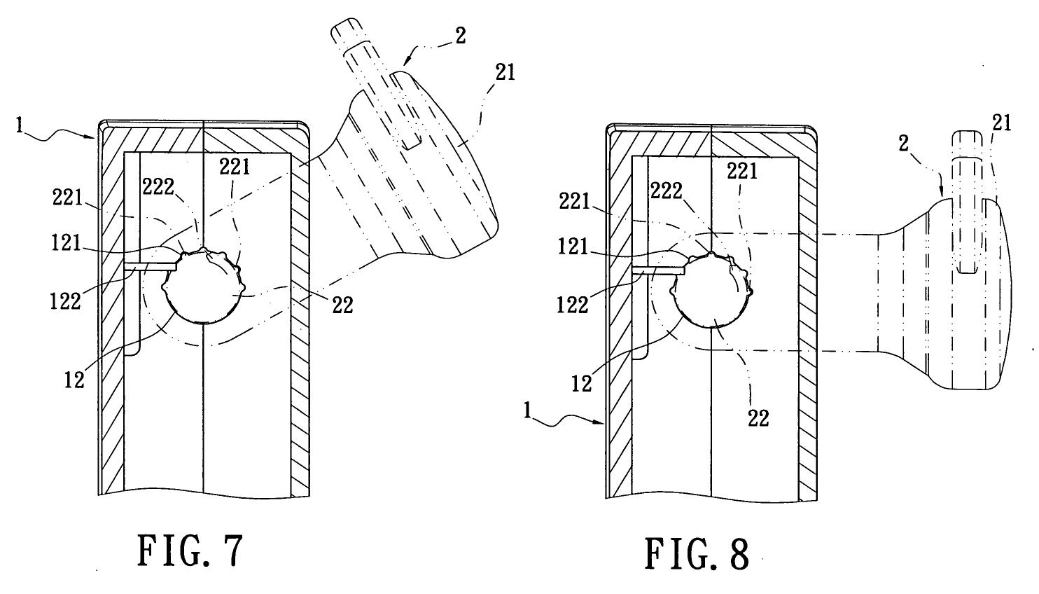

Reference is made to FIGS. 4, 6, 7 and 8. When the earphone 2 extends to an outside of the housing 1, it utilizes the convex portions 2 21 of the pivoting shafts 22 that fit in the concave portions 121 of the pivoting holes 12 to allow the earphone 2 to rotate and be positioned with multiple steps and become firmly maintained at the extending status when the earphone 2 is rotating with the housing 1.

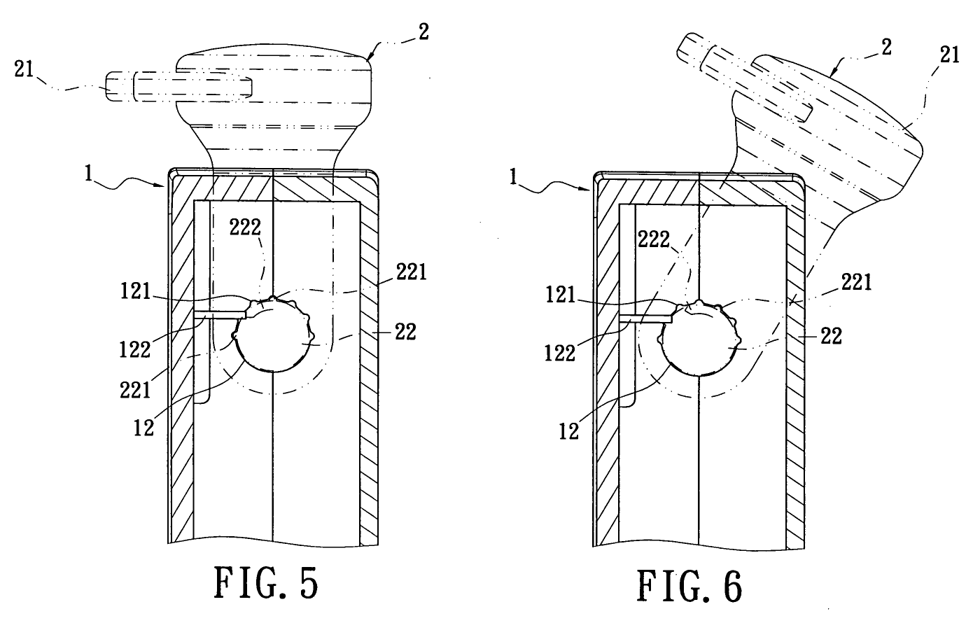

Reference is made to FIGS. 3 and 5. When the earphone 2 is received in the opening slot 11 of the housing 1, the protruding portions 222 of the pivoting shafts 22 block the blocking portions 122 in the pivoting holes 12 to restrict the rotating position of the earphone 2 within the opening slot 11 of the housing 1. By cooperating with the convex portions 221 and the concave portions 121, the earphone 2 is firmly positioned in the opening slot 11.

When the user uses the multiple steps to position and adjust the angle of the earphone 2, the user uses his or her fingers to adjust the angle between the earphone 2 and the housing 1 by pushing to match the user's face. The user can comfortably communicate with another person.

When the wireless earphone is not being used, the earphone 2 is received in the opening slot 11. Thereby, the wireless phone can be received in, for example, a pocket or a wallet. Because the earphone does not extend to the outside of the housing 1, the earphone 2 will not be broken due to the external forces.

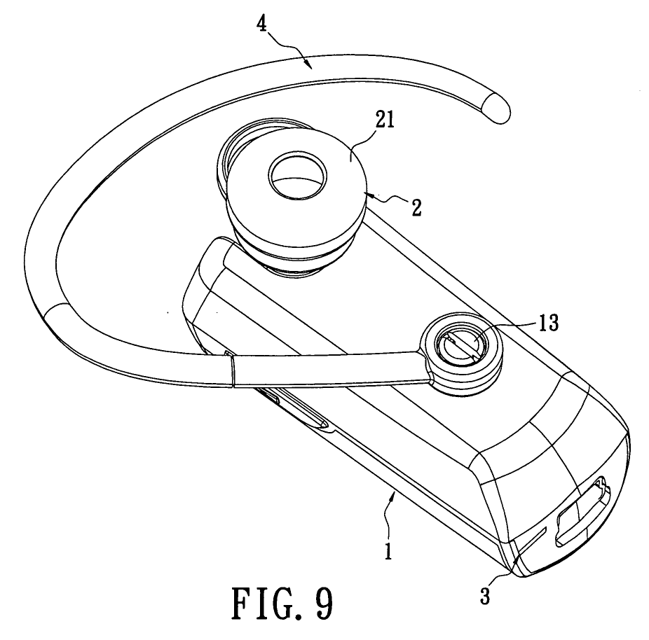

Reference is made to FIG. 9. The housing 1 further includes a connecting base 13. The connecting base 13 is pivoted with an ear hanger 4. The outline of the ear hanger 4 matches the outline of a human being's ears. The ear hanger 4 can rotated with and positioned at the connecting base 13 by a step-less method or multiple-step method. Therefore, the user can adjust the relative position between the housing 1 and the user's face and stably hang the earphone 2.

The earphone receiving structure has the following characteristics:

1. The earphone can be firmly received in the opening slot 11 of the housing. The problem of the earphone being broken by external forces is avoided. When the earphone is not being used, it can be placed anywhere. The earphone will not be damaged and it is convenient to carry it around.

2. By using the multiple steps positioning function of the pivoting shafts 22, the relative angle between the housing 1 and the earphone 2 is adjusted so as to match the user's face. The user can comfortably communicate with another person, and experience trouble-free communication.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. An earphone receiving structure, comprising:
a housing having an opening slot, wherein the opening slot is formed by an indent formed inwards from one end of the housing, there is a pair of pivoting holes in the opening slot, and a plurality of concave portions on the inner surface of the pair of the pivoting holes; and
an earphone having a pair of pivoting shafts, wherein the pair of pivoting shafts is pivoted in the pair of pivoting holes, there is at least one convex portion on the outer surface of the pair of pivoting shafts, the convex portion of the pair of pivoting shafts fits in the concave portions of the pair of the pivoting holes;
thereby, the earphone is received in the opening slot and can be rotated to an outside of the opening slot.

2. The earphone receiving structure as claimed in claim 1, wherein the pair of pivoting shafts has a protruding portion, there is a blocking portion formed in the pair of pivoting holes that correspond to the protruding portion, and the protruding portion blocks the blocking portion.

3. The earphone receiving structure as claimed in claim 1, wherein the housing further comprises a connecting base, and there is an ear hanger on the connecting base.

4. The earphone receiving structure as claimed in claim 3, wherein the outline of the ear hanger matches human being's ear.

5. The earphone receiving structure as claimed in claim 1, wherein the housing has a wireless receiving and sending device.
